(19) United States
(12) Patent Application Publication
(10) Pub. No.: US 2024/0102387 A1
(43) Pub. Date: Mar. 28, 2024

(54) HUMAN INTERFACE OPERATING DEVICE OF AN UNDERGROUND MINING MACHINE

(71) Applicant: Caterpillar Inc., Peoria, IL (US)

(72) Inventor: Alexander BECKER, Bochum (DE)

(73) Assignee: Caterpillar Inc., Peoria, IL (US)

(21) Appl. No.: 17/768,946

(22) PCT Filed: Oct. 16, 2020
(86) PCT No.: PCT/EP2020/025460

§ 371 Date: Apr. 14, 2022

(30) Foreign Application Priority Data
Oct. 24, 2019 (GB) 1915415.2

(51) Int. Cl. E21F 9/00

(52) U.S. Cl. CPC E21F 9/00

(57) ABSTRACT

The present invention refers to a human interface operating device of an underground mining machine, comprising a rotatably and axially actuatable control element for controlling functions of the underground mining machine,

### TECHNICAL FIELD

The present invention refers to a human interface operating device of an underground mining machine and to an underground mining machine which is equipped with such a human interface operating device.

### TECHNOLOGICAL BACKGROUND

Due to their operational environment, underground mining machines are subjected to high potential hazard during operation. Particularly, underground mining machines are usually used in an environment with a potentially explosive atmosphere where methane is present. Therefore, such systems have to meet demanding regulatory requirements as regards explosion prevention to avoid that any source of ignition is exposed to the potentially explosive atmosphere surrounding the mining machine during its operation.

Large underground mining machines, such as longwall mining machines, are equipped with control cabinets having a human interface device for receiving input from an operator, based on which a function of the mining machine is controlled. These control cabinets are typically exposed to the potentially explosive atmosphere and, accordingly, have to meet the demanding regulatory requirements in view of explosion prevention,

Control cabinets of underground mining machines are known which are equipped with a human-machine interface formed by a plurality of individually provided control elements for controlling the function of the mining machine and its components. These control elements may be provided in the form of translationally actuatable buttons, i.e. which are actuated upon being pushed by an operator, Alternatively or additionally, control elements may be employed which are actuated upon being rotated or pivoted by an operator.

### SUMMARY OF THE INVENTION

Starting from the prior art, it is an objective to provide an improved human interface operating device for use in an underground mining machine. It may also be an objective to provide a. human interface operating device which in particular has an improved user operability and, at the same time, meets the regulatory requirements for such an application, Further, it is an objective to provide an underground mining machine which is equipped with such a human interface operating device.

These objectives are solved by means of a human interface operating device and an underground mining machine according to the independent claims. Preferred embodiments are set forth in the present specification, the Figures as well as the dependent claims.

### BRIEF DESCRIPTION OF THE DRAWINGS

The present disclosure will be more readily appreciated by reference to the following detailed description when being considered in connection with the accompanying drawings in which:

FIG. 1 schematically shows a front view of a human-machine interface of a control cabinet installed in an underground mining machine;

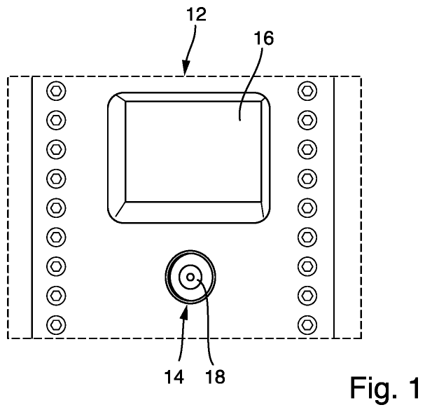

FIG. 2 schematically shows a cross-sectional view of an operating device of the human-machine interface depicted in FIG. 1; and

FIG. 3 schematically shows an exploded view of the operating device depicted in Figs, 1 and 2.

### DETAILED DESCRIPTION OF PREFERRED EMBODIMENTS

In the following, the invention will be explained in more detail with reference to the accompanying Figures. in the Figures, like elements are denoted by identical reference numerals and repeated description thereof may be omitted in order to avoid redundancies.

Fig, 1 shows a human-machine interface (HMI) 12 installed in a control cabinet of an underground mining machine (not shown), such as a longwall mining machine, in the following referred to as “the mining machine”. Specifically, the control cabinet may be provided in the mining machine such that the HMI 12 is arranged at an outer surface thereof so as to be easily accessible for an operator. In this way, the HMI 12 is exposed to an environment of the mining machine and thus, during operation, may be subjected to a potentially explosive atmosphere,

Generally, the HMI 12 refers to an interface of the mining machine, via which an operator interacts with the mining machine, i.e. a control cabinet (not shown) thereof , for controlling functions or for monitoring operating conditions thereof

In the shown configuration, the HMI 12 comprises an input unit in the form of a human interface operating device 14 for receiving a user input from the operator, in response of which functions of the mining machine are to be controlled. Further, the HMI 12 comprises a display unit 16 for providing information, e.g. feedback information, to the operator about operating conditions or parameters of the mining machine. In other words, by means of the HMI 12, operation of the mining machine can be controlled and supervised by an operator,

For receiving user input, the operating device 14 is provided with a physical component in the form of a control element 18 which is intended and configured for being actuated by an operator, i.e. by an operator's hand. In this way, the operating device 14 enables that the operator gives input to the control cabinet for controlling the mining machine. Specifically, by actuating the control element 18 of the operating device 14, the operator can control functions of the mining machine, such as setting operating parameters, setting operating conditions, reading out operating parameters, reading status messages, performing test functions, etc. More specifically, for doing so, the operator may use the control element 18 so as to navigate, e.g. scroll, through a menu list displayed to the user by the display unit 16 and to select individual menu items from the menu list so as to cause the control cabinet or the mining machine to perform a function associated to the selected menu item.

To that end, the display unit 16 may be a touch-sensitive display unit, i.e. having a touchscreen, and may constitute a further input unit, i.e. In addition to the operating device 14. In such a configuration, the HMI 12 is provided with redundancy to increase its reliability. In other words, an operator can control functions of the mining machine by using either the operating device 14 or the touchscreen of the display unit 16.

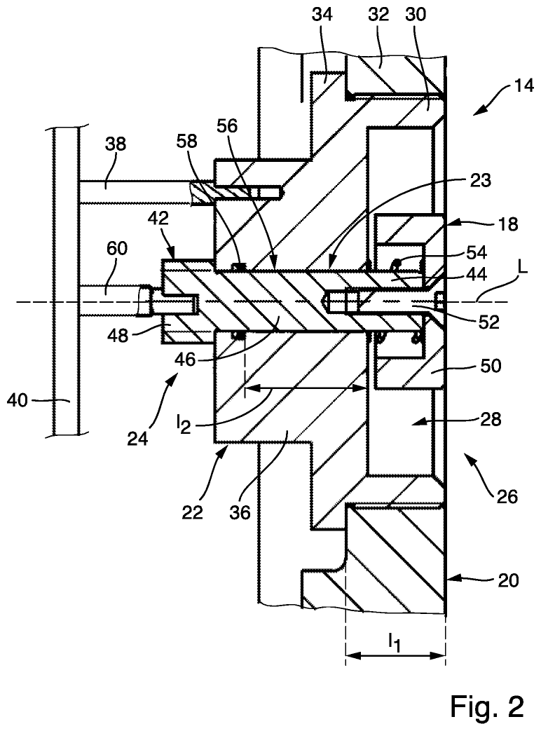

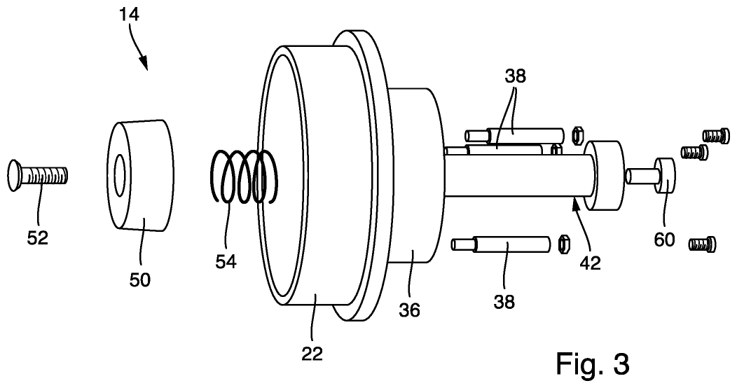

In the following, the structural configuration of the operating device 14. which constitutes a human interface operating device, is specified with reference to FIGS. 2 and 3.

The operating device 14 is configured and designed such that, in a mounted state of the operating device 14 in which it is secured to a housing 20 of the control cabinet as depicted in FIG. 2, it forms a flameproof enclosure according to the IEC 60079-1 standard, in particular the IEC 60079-1:2014 standard, for sealing an inside from an outside of the control cabinet. In other words, the shown operating device 14 forms a flameproof enclosure of the control cabinet which meets the requirements set forth in the IEC 60079-1 standard, in particular the IEC 60079-1:2014 standard. By doing so, the operating device 14 is configured and designed such that, in the mounted state, it has a pressure resistance of more than 5 bar, for example, 10 bar, In other words, the operating device 14 is designed so as to withstand a pressure difference, e.g. of 5 bar or more than 5 bar, between the inside and the outside of the housing 20 of the control cabinet. Such a pressure difference may occur due to a malfunction, particularly an unintended explosion within the control cabinet.

With such a configuration, the inside of the control cabinet may be sufficiently sealed from its outside when being used for the intended application. In other words, even if an unintended explosion occurs within the housing 20 of the control cabinet during operation of the mining machine, it may be prevented that a potentially explosive atmosphere present around the control cabinet becomes inflamed thereby, particularly by a flame propagating through the housing 20, the operating device 14 or a junction therebetween.

As regards its structural configuration, the operating device 14 comprises a base body 22 which is secured to the housing 20 of the control cabinet. The base body 22 supports the control element 18 which is partly accommodated therein. Specifically, the base body 22 includes a through bore 23 extending along a longitudinal axis L of the operating device 14, within which the control element 18 is received. The through bore 23 extends from an inner end 24 towards an outer end 26 of the operating device 14 and opens into a recess 28 provide at the outer end 26. In the context of the present disclosure, the term “inner end” refers to an end section of the operating device 14 which, in the mounted state in which the operating device 14 is secured to the housing 20 of the control cabinet, is accommodated in the inside of the control cabinet. Accordingly, the term “outer end” refers to an end section of the operating device 14 which is arranged opposed to the inner end 24 and which, in the mounted state, is exposed to the outside of the control cabinet, i.e. the environmental atmosphere of the mining machine.

A circumferential outer surface of the base body 22 comprises three adjacent and cylindrically shaped portions being provided with differing diameters, Particularly, at the outer end 26, the base body 22 includes a threaded portion 30 that is releasably secured to the housing 20 by means of a threaded connection. Specifically, the housing 20 is provided with a bore, an inner surface of which is provided with a further threaded portion 32 that is designed complementary to and engaged with the threaded portion 30 of the base body 22.

Adjacent to the further portion 30, the base body 22 includes a protruding portion 34 which, in a radial direction of the base body, Le. perpendicular to the longitudinal axis L, extends beyond the threaded portion 30. Specifically, the protruding portion 34 is designed and configured such that, in the mounted state, a lateral outer surface, i.e. which faces the outside end 26, abuts on a lateral inner surface of the housing 20, i.e. which faces the inside of the control cabinet.

Further, at the inner end 24, the base body 22 further includes a lowered portion 36 having a diameter that is lower compared to the threaded portion 32, As can be gathered from FIGS. 2 and 3, three spacer screws 38 are secured to an end surface of the lower portion 36, by means of which a circuit board 40 of the operating device 14 is hold in a predefined position relative to the base body 22. Specifically, the circuit board 40 is fastened to the spacer screws 38 by means of further screws as indicated in FIG. 3, in which, for overview reasons, the circuit board 40 is not shown.

As set forth above, the base body 22 is secured to the housing 20 by means of a threaded connection. In this configuration, the coupling between the base body 22 and the housing 20 is provided such that it forms a flameproof enclosure according to the IEC 60079-1 standard, in particular the 1EC 60079-1:2014 standard, For doing so, the threaded connection between the base body 22 and the housing 20 is designed so as to fulfill the corresponding requirements set forth in the IEC 60079-1 standard, in particular the IEC 60079-1:2014 standard. Particularly, to form a flameproof enclosure, a gap formed between the engaged threaded portions 30, 32 of the based body 22 and the housing 20 is provided with a certain gap width and a certain gap length, in the shown configuration, the threaded connection between the base body 22 and the housing 20 is provided with a size of M95, a pitch of 1.5 and a fit of 6g/6H. Further, the threaded connection extends along the longitudinal axis L over 23 mm. In other words, the threaded connection is provided with a length of 23 mm.

As can be gathered from FIG. 2, the longitudinal axis L of the operating device 14 coincides with the longitudinal or rotational axis of the control element 18, The control element 18 is built up from a plurality of separated components which are releasably secured to one another for facilitating assembly and disassembly of the operating device 14, As to substance, the control element 18 comprises a shaft 42 which extends through the through bore 23 of the base body 20 such that an outer end section 44 thereof protrudes into the recess 28. As can be gathered from FIG. 2, the shaft 42 comprises two adjacent and cylindrically shaped portions of different diameters. Specifically, the shaft 42 includes an engagement portion 46 which is received within and complementary designed to the through bore 23 of the base body 22, At the inner end 24, the shaft 42 includes a widened portion 48 having a diameter that is greater compared to the engagement portion 46 of the shaft 42. In other words, the widened portion 48 protrudes beyond the engagement portion 46 in a radial direction of the control element 18. The control element 18 further comprises a knob 50 which is releasably and force-fittingly mounted to the outer end section 44 of the shaft 42 by means of a connecting screw 52, The knob 50 has a diameter which is greater than the diameter of the engagement portion 46 of the shaft 42, Further, the knob 50 is received within the recess 28. In this way, the control element 18 is protected from being exerted to unintended high forces, For example, by such an arrangement, when being used in a mine, the control element 18 is shielded from rocks falling down from a ceiling of the mine, Further, for improving its operability, the knob is provided with a knurled surface, particularly at its circumferential outer surface,

The control element 18 further comprises a helical spring element 54 arranged around the outer surface of the shaft 42, particularly around its outer end section 44. Specifically, the spring element 54 is interposed between the knob 50 and an outer surface of the operating device 14, particularly an inner bottom of the base body's recess 28.

In the shown configuration, the control element 18 is provided in the form of a rotatably and axially actuatable control element for controlling functions of the underground mining machine. In other words, the control element 18 is configured and designed such that it can be actuated by an operator upon rotating the control element 18. Further, the control element 18 is configured and designed such that it can be actuated by an operator upon translationally moving the control element 18, Thus, upon rotationally or axially actuating the control element 18, an operator can navigate through the menu list displayed onto the display unit 16 and select individual menu items to perform an associated function of the mining machine. For example, upon rotating the control element 18, an operator may navigate through the menu list so as to highlight a desired menu item. Then, upon pushing i.e. translationally actuating, the control element. 18, the operator may select the highlighted menu item so as to perform a function associated thereto.

More specifically, the control element 18 is designed and configured such that it is rotationally actuatable around and axially actuatable along its longitudinal axis L. For doing so, the control element 18 is rotatably and translationally supported in the base body 22 of the operating device 14 by means of a plain bearing 56. By this configuration, the control element 18 may be rotated relative to the base body 22 around its longitudinal axis L upon being rotationally actuated by an operator. Further, the control element 18 may be translationally or axially moved relative to the base body 22 along its longitudinal axis L upon being translationally actuated, i.e. pushed, by an operator, The axial movement of the control element 18 is limited. This means that the control element 18 may be translationally moved in the base body 22 within a predefined area. Specifically, as can be gathered from FIG. 2, a relative translational movement between the control element 18 and the base body 22 is delimited, on the one side, by the widened portion 48 of the shaft 42 and, on the other side, by the knob 50. This structural configuration may contribute to the pressure resistance of the operating device 14,

The plain bearing 56 of the operating device 14 is formed by the shaft 42, i.e. its engagement portion 46, and the through bore 23 of the base body 22 which are engaged to one another. For allowing that the control element 18 can be actuated relative to the base body 20 in a convenient way for an operator, a defined gap is provided between the shaft 42, i.e. its engagement portion 46, and the through bore 23 of the base body 22. In this way, a plain fit between the shaft 42, i.e. its engagement portion 46, and the through bore 23 of the base body 22 is provided. The plain bearing 56 forms a flameproof enclosure according to the IEC 60079-1 standard, in particular the IEC 60079-1:2014 standard, In this way, it may be avoided that, in case of an unintended explosion in the inside of the control cabinet, a flame or any other medium capable of inflaming a potentially explosive atmosphere present at the outside of the control cabinet propagates through the gap between the shaft 42 and the trough bore 23. For doing so, the gap between the shaft 42 and the base body 22 of the operating device 14 is designed so as to fulfill the corresponding requirements set forth in the IEC 60079-1 standard, in particular the IEC 60079-1:2014 standard, Particularly, in the suggested plain bearing 56, the gap between the shaft 42 and the base body 22 is provided with a certain gap width and a certain length. in the shown configuration, the plain fit between the shaft 42 and the through bore 23 is provided with a nominal size range of substantially 14 mm and a fit of H8/d9. In other words, between the shaft 42 and the through bore 23, a clearance fit may be provided with a tolerance between 0 and +70 μm. Further, the plain bearing 56 extends along the longitudinal axis over 25 mm. In other words, the plain bearing 56 is provided with a length I₂ of 25 mm.

For supporting the sealing effect of the gap provided between the shaft 42 and the through bore 23, a sealing ring 58 is arranged between the shaft 42 and the through bore 23. Specifically, the sealing ring 58 is disposed within a groove provided at the inner surface of the through bore 23 within the base body 22, thereby forming a seal joint between the shaft 42 and the through bore 23 of the base body 22.

Furthermore, at the inside end 24, the control element 18, particularly via the widened portion 48 of the shaft 42, is force- or form-fittingly connected to a sensor unit 60 which is mounted onto the circuit board 40. The sensor unit 60 is configured to sense or determine a rotational movement of the control element 18 relative to the base body 22 around its longitudinal axis L. Further, the sensor unit 60 is configured to sense or determine a translational movement of the control element 18 relative to the base body 22 along its longitudinal axis L. Based on the sensed or determined movements of the control element 18, the sensor unit. 60 generates an electric information signal which is transmitted to a data processor of the control cabinet which processes and interprets the received information signal so as to control the function of the mining machine.

As set forth above, the control element 18 comprises the spring element 54 which is interposed between the knob 50 and the base body 22, In this way, the control element 18 is biased towards a neutral position as depicted in FIG. 2, in which at least one of an axial position or orientation of the control element 18 is predefined relative to the base body 22 of the operating device 14. In other words, when an operator actuates and thereafter releases the control element 18, it is returned from its actuated position to its neutral position due to an elastic force exerted to the control element 18 by means of the spring element 56.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

This is in particular the case with respect to the following optional features which may be combined with some or all embodiments, items and/or features mentioned before in any technically feasible combination.

A human interface operating device, referred to as “the operating device” in the following, of an underground mining machine may be provided. The operating device may comprise a rotatably and axially actuatable control element for controlling functions of the underground mining machine, referred to as “the mining machine” in the following.

By being provided with the control element, which can be actuated by an operator upon being rotationally as well as translationally moved, the suggested operating device of the mining machine can be operated in a more intuitive and more convenient way-. Compared to known operating devices which are provided with control elements which are actuatable either rotationally or translationally, the suggested operating device enables an operator to provide his input to a single control element while allowing for a higher degree of freedom for interacting therewith. As a result, the suggested operating device is provided with an improved operability.

The proposed operating device may be intended to be used in a control cabinet of an underground mining machine, such as a. longwall mining machine, but is not limited to this application. Rather, it may be used in any application which is subjected to regulatory requirements in view of explosion prevention.

Specifically, the operating device may be configured and designed such that, in the mounted state of the operating device in which it is secured to a housing of a control cabinet, it forms a flameproof enclosure according to the IEC 60079-1 standard, particularly the IEC 60079-1:2014 standard. Further, the operating device may be configured and designed such that, in the mounted state, it has a compressive strength or pressure resistance of 5 bar or more than 5 bar, e.g. of 10 bar.

In a further development, the control element may be rotationally actuatable around and axially actuatable along a longitudinal axis of at least one of the operating device and the control element. For doing so, the operating device may comprise a base body configured to be secured to a housing of a control cabinet of the underground mining machine. In this configuration, the control element may be rotatably and translationally supported in the base body. More specifically, the control element may be rotatably and translationally supported in the base body by means of a plain bearing. The plain bearing may be formed by a shaft of the control element and a through bore provided at the base body. The shaft and the base body may be engaged to one another so as to form the plain bearing,

Further, the plain hearing may form a flameproof enclosure according to the IEC 60079-1 standard, particularly the IEC 60079-1:2014 standard. In other words, the plain bearing may form a flameproof enclosure having a protective class “d” according to the IEC 60079-1standard.

Specifically, the plain bearing may be configured such that the shaft and the through bore are provided with a plain fit relative to one another, By being provided with a plain fit, a gap between the shaft and the through bore are provided with a sealing effect which may contribute to the flameproof enclosure. As an example, the plain fit provided between the shaft and the through bore may have a nominal size range of substantially 14 mm and a plain fit of H8/d9, Further, the plain bearing may extend along the longitudinal axis over at least 15 mm, e.g. over at least 20 mm. In one configuration, the plain bearing may extend along the longitudinal axis over substantially 25 mm. The suggested operating device is not limited to this configuration, Rather, the skilled person understands that any plain bearing fulfilling the requirements set forth in the IEC 60079-1 standard may fall under the scope of the suggested operating device,

In a further development, e.g. in the range of an inside end of the plain bearing, a sealing ring may be provided between the shaft and the base body, Le. its through bore, In the context of the present disclosure, the term “inside end of the plain hearing” may refer to an end section thereof which, in a mounted state of the operating device, faces an inside of the housing of the control cabinet.

The control element may be connected to a sensor unit. The sensor unit may be configured to sense or determine a rotational and axial movement of the control element Specifically, the sensor unit may be configured to sense or determine a rotational movement of the control element around its longitudinal axis and an axial movement of the control element along its longitudinal axis.

In a further development, the control element may be biased towards a neutral or non-actuated position, in which at least one of an axial position or actual orientation of the control element relative to the base body predefined, For doing so, the operating device may be provided with a spring element which is interposed between the base body and the control element.

Further, the control element, at an inside-end section, may be provided with a widened portion which, in a radial direction of the control element, protrudes beyond an engagement portion of the shaft, i.e. which is engaged with the through bore of the base body, Further, the control element, at an outside end section being opposed to its inside end section, may be provided with a knob releasably mounted to the shaft. In this configuration, the spring element may be interposed between the knob and an outer surface of the base body,

Furthermore, an underground mining machine may be provided which is equipped with an above-described human interface operating device, Since the proposed underground mining machine is equipped with the above-described human interface operating device, technical features which are described in connection with the operating device in the present disclosure may also relate and be applied to the underground mining machine.

### Industrial Applicability

With reference to the Figures, a human interface operating device 14 and an underground mining machine being equipped with such operating device 14 are suggested. The suggested operating device 14 as mentioned above is applicable in any control cabinet of an underground mining machine. Further, the operating device 14 may replace conventional human interface operating devices and may serve as a replacement or retrofit part.

1. A human interface operating device of an underground mining machine, comprising a rotatably and axially actuatable control element for controlling functions of the underground mining machine.

2. The human interface operating device according to claim 1, which is configured and designed such that, in a mounted state of the operating device in which it is secured to a housing of a control cabinet, it forms a flameproof enclosure according to the IEC 60079-1 standard.

3. The human interface operating device according to claim 1 or 2, which is configured and designed such that, in the mounted state, it has a pressure resistance of 5 bar.

4. The human interface operating device according to claim 1, wherein the control element is rotationally actuatable around and axially actuatable along its longitudinal axis (L).

5. The human interface operating device according to claim 1, which further comprises a base body configured to be secured to a housing of a control cabinet of the underground mining machine, wherein the control element is rotatably and translationally supported in the base body.

6. The human interface operating device according to item 5, wherein the control element is rotatably and translationally supported in the base body by means of a plain bearing formed by a shaft of the control element and a through bore provided at the base body which are engaged to one another.

7. The human interface operating device according to claim 6, wherein the plain bearing forms a flameproof enclosure according to the IEC 60079-1 standard.

8. The human interface operating device according to claim 6, wherein the shaft and the through bore are provided with a plain fit having a nominal size range of 14 mm and a fit of H8/d9.

9. The human interface operating device according to claim 6, wherein the plain bearing extends along the longitudinal axis (L) of the control element over at least 15 mm.

10. The human interface operating device according to claim 6, wherein in the range of an inside end of the plain bearing, a sealing ring is provided between the base body and the shaft of the control element.

11. The human interface operating device according to claim 1, wherein the control element is connected to a sensor unit which is configured to sense a rotational and axial movement of the control element.

12. The human interface operating device according to claim 5, wherein the control element is biased towards a neutral position, in which at least one of an axial position or orientation of the control element relative to the base body is predefined.

13. The human interface operating device according to claim 5, wherein the control element, at an inside-end section, is provided with a widened portion which, in a radial direction of the control element, protrudes beyond an engagement portion of the shaft, wherein the control element, at an outside-end section, is provided with a knob releasably mounted to the shaft, and wherein a spring element is interposed between the knob and an outer surface of the base body.

14. The underground mining machine having a human interface operating device according to claim 1.
